(19) United States
(12) Patent Application Publication
(10) Pub. No.: US 2014/0376215 A1
(43) Pub. Date: Dec. 25, 2014

(54) Photoelectric Recovery Device For Use In Lighting Device

(71) Applicant: Wen-Tsung Lin, New Taipei City (TW)

(72) Inventor: Wen-Tsung Lin, New Taipei City (TW)

(21) Appl. No.: 14/483,157

(22) Filed: Sep. 11, 2014

Related U.S. Application Data
(63) Continuation-in-part of application No. 13/169,053, filed on Jun. 27, 2011.

(51) Int. Cl. F21S 9/03; F21V 23/04

(52) U.S. Cl. CPC F21S 9/037; F21V 23/0464
USPC 362/183

(57) ABSTRACT

A photoelectric recovery device for use in a lighting device includes a controller unit; at least one light emission element, each light emission element being electrically connected to the controller unit; at least one light recovery module, each light recovery module being electrically connected to the controller unit, each light recovery module being arranged adjacent to the light emission element; and an electricity accumulation unit, the electricity accumulation unit being electrically connected to the controller unit, the electricity accumulation unit storing electricity from the light recovery module. Each light recovery module is mounted in the lighting device and each light recovery module receives extra light from the light emission element of the lighting device, which is subjected to photoelectric conversion from optical energy into electrical energy. The electrical energy is stored in the electricity accumulation unit for secondary use.

### CROSS-REFERENCE TO RELATED APPLICATIONS

This application is a continuation-in-part of U.S. patent application Ser. No. 13/169,053, filed Jun. 7, 2011.

### BACKGROUND OF THE INVENTION

(a) Technical Field of the Invention

The present invention generally relates to a photoelectric recovery device for use in a lighting device, and more particularly to a photoelectric recovery device that comprises a light recovery unit that acquires extra light from a light emission element of a lighting device, which is subjected to photoelectric conversion into electrical energy and stores such electric energy in an electricity accumulation unit for secondary use so as to achieve increased utilization of green energy of a product and reduced consumption of energy thereby making energy repeatedly usable.

(b) Description of the Prior Art

Recently, due to nuclear disasters and abnormal changes of weather that make the whole world suffering a great loss of property and lives and further due to gradual reduction of storage and production of the natural resources that leads to increasingly heightening of the prices, every country is taking serious consideration of the important issues of environmental conservation, energy saving, and carbon reduction that are of great concerns about the future of human beings. Due to the rising of environmental conservation, green energies are attracting increasing attention, and the beneficial advantages of solar energy become emerging.

A conventional light bulb (lighting device) is composed of a luminous object that is electrically connected to a power source and, once energized, emits light. However, a major amount of the energy is used in heat and the optical energy that can be used is often spread over undesired locations. For example, light emitting to a non-lighting surface of a light fixture and the light of an LED that is subjected to undesired scattering and reflection. This leads to a waster of energy. Such shortcomings and insufficiency of the known lighting devices are surely imperfect designs and further improvements are needed.

Thus, the technical issue that the present invention aims to overcome is to eliminate the above-discussed problems.

### SUMMARY OF THE INVENTION

In view of the above-discussed drawbacks of the known device, an object of the present invention is to provide a photoelectric recovery device for use in a lighting device, wherein a light recovery module acquires extra light from a light emission element of a lighting device, which is subjected to photoelectric conversion into electrical energy, and such electric energy is stored in an electricity accumulation unit for secondary use so as to achieve increased utilization of green energy of a product and reduced consumption of energy thereby making energy repeatedly usable.

To achieve the above object, the present invention provides a photoelectric recovery device for use in a lighting device, which comprises:

a controller unit;

at least one light emission element, wherein each light emission element is electrically connected to the controller unit;

at least one light recovery module, wherein each light recovery module is electrically connected to the controller unit, each light recovery module being arranged adjacent to the light emission element; and

an electricity accumulation unit, wherein the electricity accumulation unit is electrically connected to the controller unit, the electricity accumulation unit storing electricity from the light recovery module;

wherein each light recovery module is mounted in the lighting device and each light recovery module receives extra light from the light emission element of the lighting device, which is subjected to photoelectric conversion from optical energy into electrical energy, the electrical energy being stored in the electricity accumulation unit for secondary use.

With the technical solution provided by the present invention, when a user switches a power supply to energize the light emission element to give off light, besides a target location being illuminated, the light recovery module also receives a portion of the light and coverts the optical energy into electrical energy to be stored in the electricity accumulation unit, whereby electricity can be supplied from the electricity accumulation unit in case of power failure or for use in a short period of time. Further, when the power supply is switched off, the controller unit can be activated by a dimming environment to individually control lighting/darkening of each of the light emission elements. Recovery and conversion of the light from the light emission element can be immediately started to achieve accumulation of electrical power when the light is set on, and the electrical power so accumulated can be fed back to energize the light emission element to thereby achieve recovery of the light from the lighting device and reuse of energy.

The present invention provides a photoelectric recovery device for use in a lighting device, wherein a light recovery module captures extra light of a light emission element of a lighting device and carries out photoelectric conversion for conversion into electrical energy that is stored in an electricity accumulation unit for secondary use thereby increasing green energy utilization of a product, reducing energy consumption, and allowing for repeated use of energy.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a block diagram illustrating the structure of the present invention.

FIG. 2 is a block diagram illustrating the operation of the present invention.

FIG. 3 is a schematic view showing an application of the photoelectric recovery device according to the present invention.

FIG. 4 is a schematic view showing another application of the photoelectric recovery device according to the present invention.

FIG. 5 is a schematic view showing a further application of the photoelectric recovery device according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

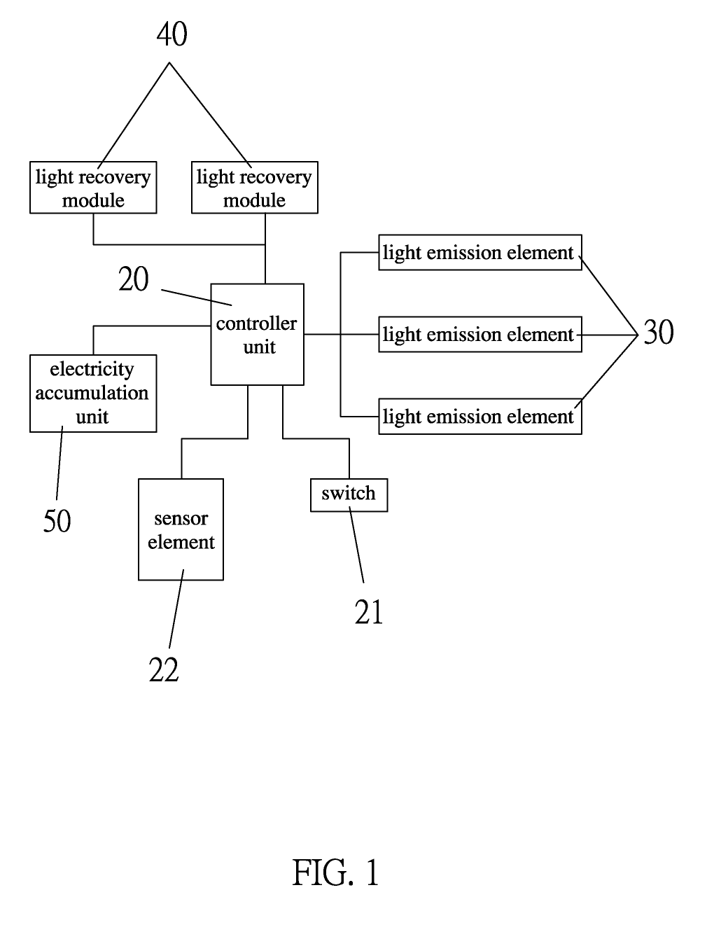

Referring to FIG. 1, the present invention provides a photoelectric recovery device for use in a lighting device, which comprises:

a controller unit 20, wherein the controller unit 20 comprises a switch 21, the switch 21 being electrically connected to the controller unit 20, the controller unit 20 comprises a sensor element 22, the sensor element 22 being electrically connected to the controller unit 20, the sensor element 22 being a photoresistor, a photosensitive element, or an infrared detector;

at least one light emission element 30, wherein each light emission element 30 is electrically connected to the controller unit 20, each light emission element 30 being a gas lighting tube, a light-emitting diode (LED), or an organic light-emitting diode (OLED), each light emission element 30 being electrically connected to the sensor element 22 of the controller unit 20;

at least one light recovery module 40, wherein each light recovery module 40 is electrically connected to the controller unit 20, each light recovery module 40 being arranged adjacent to the light emission element 30, each light recovery module 40 being a solar energy chip, a solar panel, or a luminous paint, the light recovery module 40 having flexibility; and

an electricity accumulation unit 50, wherein the electricity accumulation unit 50 is electrically connected to the controller unit 20, the electricity accumulation unit 50 receiving and storing therein electrical power from the light recovery module 40, the electricity accumulation unit 50 being a supercapacitor, a secondary battery, a rechargeable battery, or a storage battery;

wherein each light recovery module 40 is arranged in a lighting device 10 and each light recovery module 40 receives extra light from the light emission element 30 of the lighting device 10 for photoelectric recovery and converts the optical energy into electrical energy, whereby the electrical energy is stored in the electricity accumulation unit 50 for secondary use.

Thus, with the technical solution adopted in the present invention, when a user switches on a power supply of the lighting device 10 to cause each light emission element 30 to emit light, besides illumination achieved with the light, the light recovery module 40 of the present invention, which is arranged adjacent to the light emission element 30, allows the light recovery module 40 to be irradiated by the light and receives and converts the optical energy of the light into electric energy, whereby the electric energy is stored in the electricity accumulation unit 50 and the electricity accumulation unit 50 may supply the electricity in a condition of failures of an external power supply or for use in a short period of time.

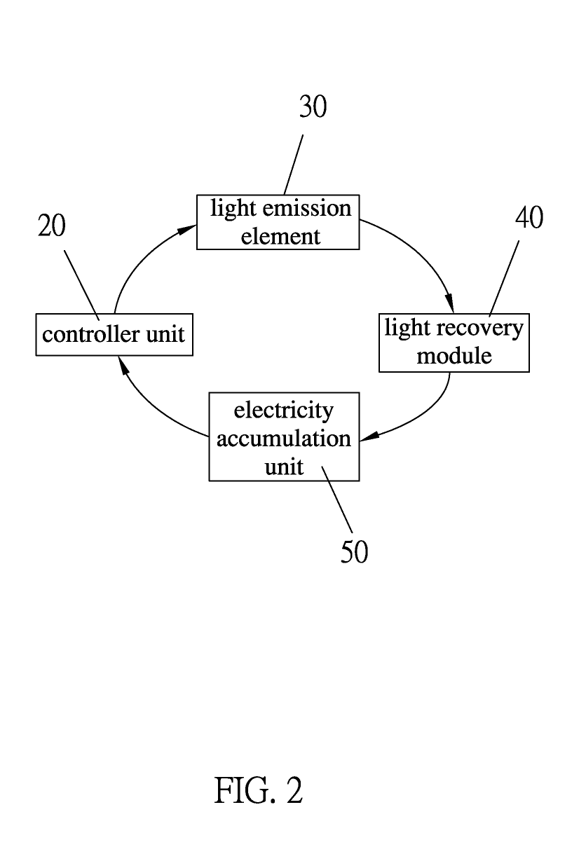

Referring to FIGS. 1 and 2, with the device of the present invention comprising a controller unit 20 and the controller unit 20 comprising a sensor element 22 and the controller unit 20 being electrically connected to each light emission element 30, when a power supply of the lighting device 10 is switched off and the environmental brightness is reducing or getting weak, the sensor element 22 issues a signal to the controller unit 20 to allow the controller unit 20 to supply electricity from the electricity accumulation unit 50 to the light emission element 30 or some of the light emission elements if there are many such elements in order to achieve a reduced power consumption of the lighting device 10. When the user no longer needs to keep the light emission element 30 or some of the light emission elements on, with the controller unit 20 being provided with the switch 21, the user may operate the switch 21 to switch on/off the power supply of the light emission element 30 so as to achieve automatic switching and energy saving. Further, the switch 21 of the controller unit 20 may be arranged to allow the user to achieve lighting of each of multiple light emission elements 30 or some of the multiple light emission elements 30 through multiple times of switching.

Further, the electricity accumulation unit 50 of the present invention can be electrically connected, with external connection, to the controller unit 20, allowing for easy replacement of the secondary battery. Further, the controller unit 20 may be electrically connected, through electrical wires, to an electric main so that when the electricity accumulation unit 50 runs up the electrical power thereof, the controller unit 20 may automatically switch to the electric main for receiving electrical power or a user may manually operate the switch 21 for such switching.

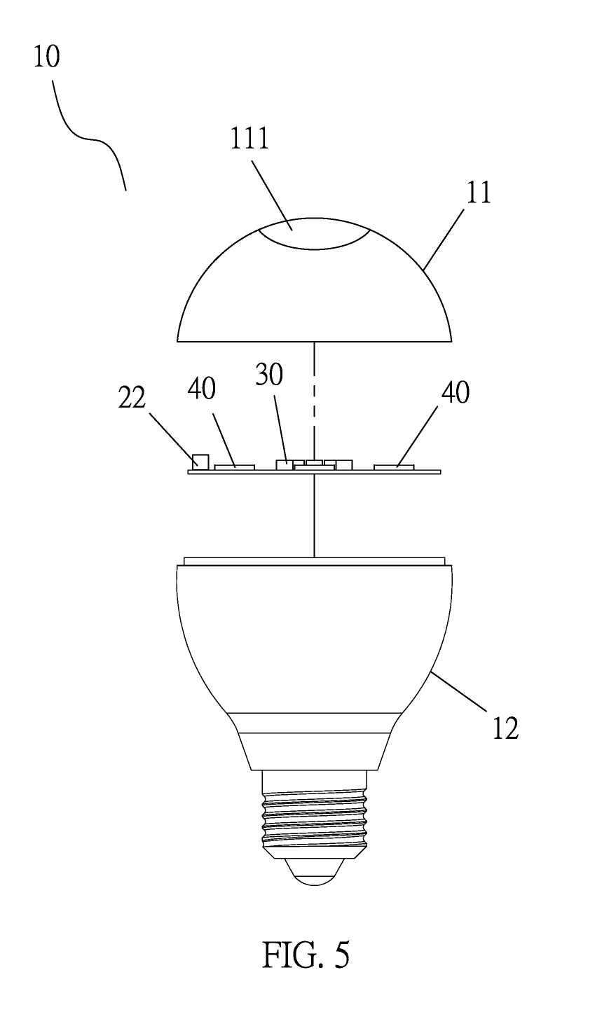

Referring to FIG. 5, the lighting device 10 may be optionally composed of a base 12 and a cover 11 mounted to each other. The lighting device 10 may accommodate therein a controller unit 20, at least one light emission element 30, at least one light recovery module 40, and an electricity accumulation unit 50. In an attempt to recover the optical energy of the light from the lighting device 10 according to the present invention, the light emission element 30 is mounted on the base 12 and the light recovery module 40 is set adjacent to the light emission element 30, so that when the light emission element 30 emits light for illumination, the light from the light source of the lighting device 10 is partly reflected to the light recovery module 40, allowing the light recovery module 40 to carry out photoelectric conversion for conversion of the light into electricity, whereby the optical energy so converted into the electrical energy is stored in the electricity accumulation unit 50 for subsequent use by the light emission element 30 thereby achieving secondary use, as demonstrated in FIG. 2.

Further, referring to FIGS. 2 and 5, the lighting device 10 may comprise a light condensing lens 111 mounted to the top of the cover 11, so that when a user installs the lighting device 10 outdoors, the natural light of the outdoor environment can be received through the light condensing lens 111 for concentrating the light, whereby the light can be subject to conversion by the light recovery module 40 from optical energy into electrical energy to be stored in the electricity accumulation unit 50, allowing for nighttime illumination by having the electricity accumulation unit 50 supplies electricity to the light emission element 30 of the lighting device 10. Further, the light from the light emission element 30 of the lighting device 10 may additionally irradiate the light recovery module 40, so as be to converted by the light recovery module 40 from optical energy into electrical energy to be stored in the electricity accumulation unit 50, thereby achieving recover and reuse of the light emitting from the lighting device 10 and thus achieving recover of light and reuse of energy.

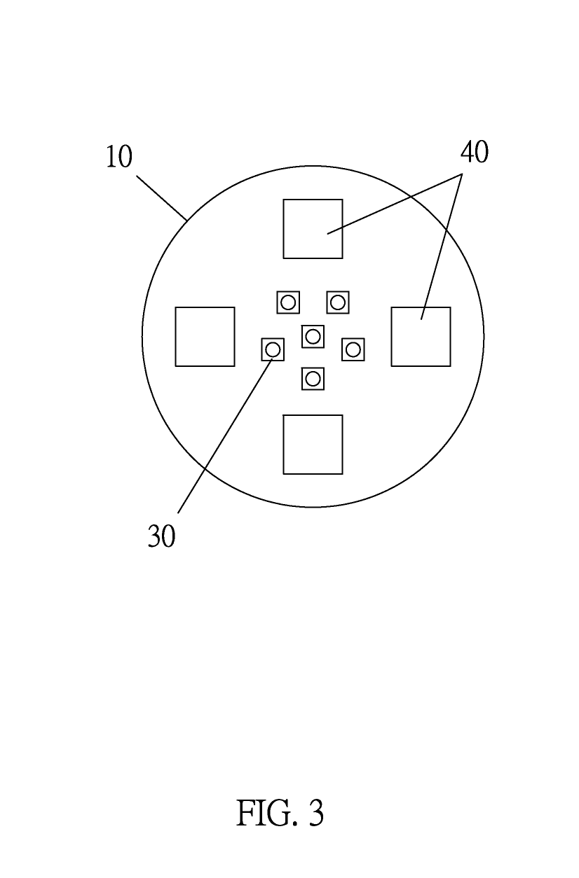

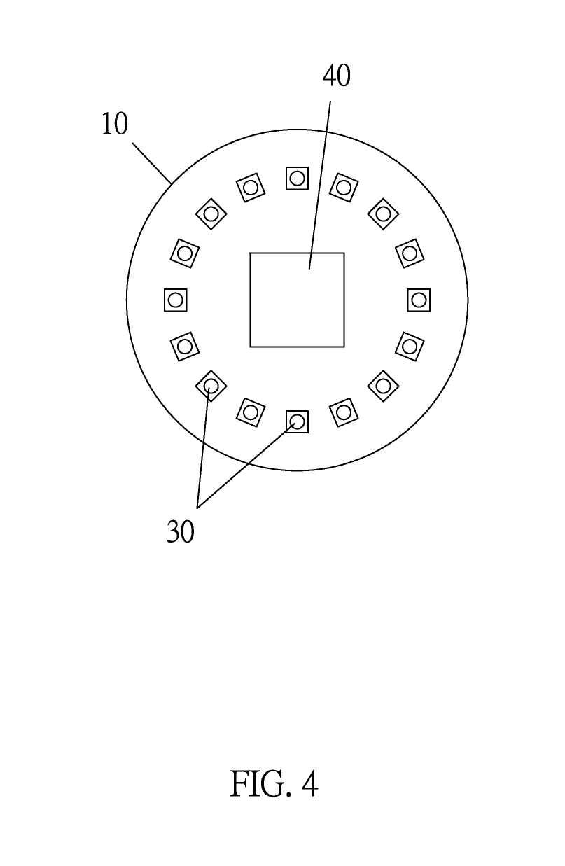

Referring to FIGS. 3 and 4, which illustrates two examples of application of the present invention, with the arrangement of at least one light recovery module 40 and at least one light emission element 30 according to the present invention and each light recovery module 40 being arranged adjacent to the light emission element 30, multiple light recovery modules 40 may be arranged to circumferentially surround multiple light emission elements 30, or alternatively, in another example of application of the present invention, multiple light emission elements 30 may be arranged to circumferentially surround a light recovery module 40 to improve the effect of recovering the light from the lighting device.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A photoelectric recovery device for use in a lighting device, comprising:
a controller unit;
at least one light emission element, wherein each light emission element is electrically connected to the controller unit;
at least one light recovery module, wherein each light recovery module is electrically connected to the controller unit, each light recovery module being arranged adjacent to the light emission element; and
an electricity accumulation unit, wherein the electricity accumulation unit is electrically connected to the controller unit, the electricity accumulation unit storing electricity from the light recovery module;
wherein each light recovery module is mounted in the lighting device and each light recovery module receives extra light from the light emission element of the lighting device, which is subjected to photoelectric conversion from optical energy into electrical energy, the electrical energy being stored in the electricity accumulation unit for secondary use.

2. The photoelectric recovery device for use in the lighting device according to claim 1, wherein the controller unit further comprises a switch.

3. The photoelectric recovery device for use in the lighting device according to claim 2, wherein the controller unit comprises a sensor element.

4. The photoelectric recovery device for use in the lighting device according to claim 3, wherein the sensor element is one of a photoresistor, a photosensitive element, and an infrared detector.

5. The photoelectric recovery device for use in the lighting device according to claim 1, wherein the light emission element is one of a gas lighting tube, a light-emitting diode (LED), and an organic light-emitting diode (OLED).

6. The photoelectric recovery device for use in the lighting device according to claim 1, wherein the light recovery module is one of a solar energy chip, a solar panel, and a luminous paint.

7. The photoelectric recovery device for use in the lighting device according to claim 1, wherein the light recovery module has flexibility.

8. The photoelectric recovery device for use in the lighting device according to claim 1, wherein the electricity accumulation unit is one of a supercapacitor, a secondary battery, a rechargeable battery, and a storage battery.

9. The photoelectric recovery device for use in the lighting device according to claim 1, wherein the lighting device comprises a base and a cover mounted to each other and the cover comprises a light condensing lens mounted to a top thereof.

10. The photoelectric recovery device for use in the lighting device according to claim 1, wherein the controller unit is adapted to electrically connected to an electric main through electrical wires so that when the electricity accumulation unit runs up electrical power thereof, the controller unit automatically switches to the electric main to receive electrical power therefrom or a user manually operate the switch to achieve the switching.

11. The photoelectric recovery device for use in the lighting device according to claim 6, wherein the light recovery module has flexibility.
